(19) United States
(12) Patent Application Publication
(10) Pub. No.: US 2011/0154387 A1
(43) Pub. Date: Jun. 23, 2011

(54) TELEVISION AUTHORIZING SYSTEM FOR PLAYING MEDIA CONTENT AND AUTHORIZING METHOD THEREOF

(75) Inventors: LUNG DAI, Tu-Cheng (TW); YAN-HU SUN, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/960,305

(22) Filed: Dec. 3, 2010

(30) Foreign Application Priority Data
Dec. 17, 2009 (CN) 200910311716.2

(51) Int. Cl. H04N 7/16

(52) U.S. Cl. 725/27; 725/28

(57) ABSTRACT

A television authorizing system comprises a storage, a display, a communicating module, a content controlling module and an output module. The communicating module receives a broadcast signal. The content controlling module acquires a content label of selected program and compares the content label with the user information in a predefined user list. The output module outputs the selected program to the display when the user is authorized.

### BACKGROUND

1. Technical Field

The present disclosure relates to an authorizing system for playing media content, and more particularly to an authorizing system verifying user authority through individual fingerprints.

2. Description of Related Art

There are several ways been developed for limiting mature media content from content provider to be accessed by children. However, the fact is mature media content is still accessible to children once they get the password in many case. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a television authorizing system 100 of the present disclosure.

FIG. 2 is a flowchart of an exemplary embodiment of an authorizing method for playing media content of the present disclosure.

### DETAILED DESCRIPTION

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

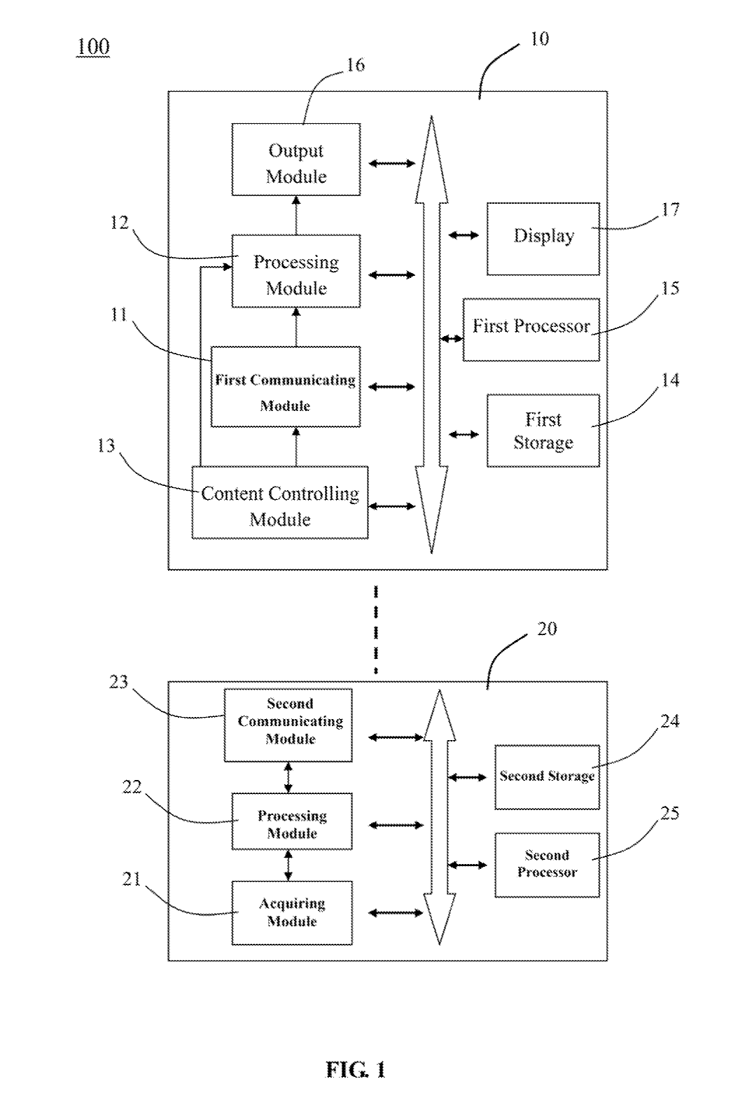

FIG. 1 is the block diagram of an exemplary embodiment of a television authorizing system 100 includes a television receiver 10 and a remote control 20. The television receiver 10 includes a first communicating module 11, a processing module 12, a content controlling module 13, a first storage 14, a first processor 15, an output module 16 and a display 17. The remote control 20 includes an acquiring module 21, a processing module 22, a second communicating module 23, a second storage 24 and a second processor 25. The TV receiver 10 receives media content, such as media program, from different content provider. The first communicating module 11, the processing module 12, the content controlling module 13 and the output module 16 are stored in the first storage 14. The first processor 15 controls the first communicating module 11, the processing module 12, the content controlling module 13, the first storage 14, the output module 16 and the display 17 to execute the functions described below. The acquiring module 21, the processing module 22 and the second communicating module 23 is stored in the second storage 24. The second processor 25 controls the acquiring module 21, the processing module 22 and the second communicating module 23 to execute the functions described below. In this exemplary embodiment, the authorizing system 100 is a LCD TV, a Plasma TV or a Projecting TV. The content provider can be an internet content provider, a cable line content provider or a digital Television Terrestrial broadcaster.

In another exemplary embodiment, the television authorizing system 100 is a WEB TV. A WEB TV basically executes its function under a personal computer construction. Therefore, the television authorizing system 100 is generally controlled and coordinated by an operating system, such as UNIX, Linux, Windows, Mac OS, an embedded operating system, or any other compatible system. Alternatively, the television authorizing system 100 may be controlled by a proprietary operating system. Typical operating systems control and schedule computer processes for execution, perform memory management, provide file system, networking, and I/O services, and provide a user interface, such as a graphical user interface (GUI), among other tasks.

In this exemplary embodiment, the first communicating module 11 communicates with the remote control 20. The first communicating module 11 receives fingerprint information from the remote control 20 and broadcast signals from a content provider. The communication between the first communicating module 11 and the remote control 20 is implemented by infrared ray communication. However, it should be noted that communication between the television receiver 10 and the remote control 20 can also be implemented through other communication means, such as BLUETOOTH technology.

The processing module 12 receives the broadcast signal from a content provider. The broadcast signal includes program content of different channels and content labels under television rating guide. The TV ratings system gives parents more information about the content and age-appropriateness of TV programs. These ratings, called the TV Parental Guidelines, are modeled after the familiar movie ratings, which parents have known and valued for decades. They are designed to be easily recognizable and simple to use. The Guidelines apply to most television programs, including those directed specifically to young children. However, sports and news shows do not carry the Guidelines. The Guidelines appear in the upper left corner of the TV screen at the beginning of TV shows, and often again after commercial breaks.

The processing module 13 acquires the content labels in the broadcast signal. The processing module 13 transfers the media program into a data stream complying with a media format supported by the output module 16. The media format supported are MPEG, RMVB, Real Player and DVIX formats. Other formats can also be supported in other embodiments.

A user list corresponding to user fingerprints is predefined and stored in the first storage 14. The user list contains information including age or authority of watching media content for each user predefined by an administrator. The content controlling module 13 receives the fingerprint information from the first communicating module 11. The content controlling module 13 confirms the user's age and authority in accordance with the fingerprint information. Then, the content controlling module 13 compares information of the user list with the content label of the program selected by the user. If the information of user list shows the user is authorized to watch this program, the content controlling module 13 controls the processing module 12 to transmit data stream of corresponding program to the output module 16 for displaying content of the program in the display 17. If the user is not authorized according to the user list, the content controlling module 13 transmits a non-authorization warning to the output module 13 to output the warning in the display 17.

The authority of a user can be defined by an administrator, such as the registered buyer. The administrator defines a user authority through combining fingerprint inputted by the remote control 20 with the information, such as user age or the authority of the user corresponding to content label. The output module 16 outputs the data stream to the display 17 if the content controlling module 13 authorizes the processing module 12 to transmit the data stream.

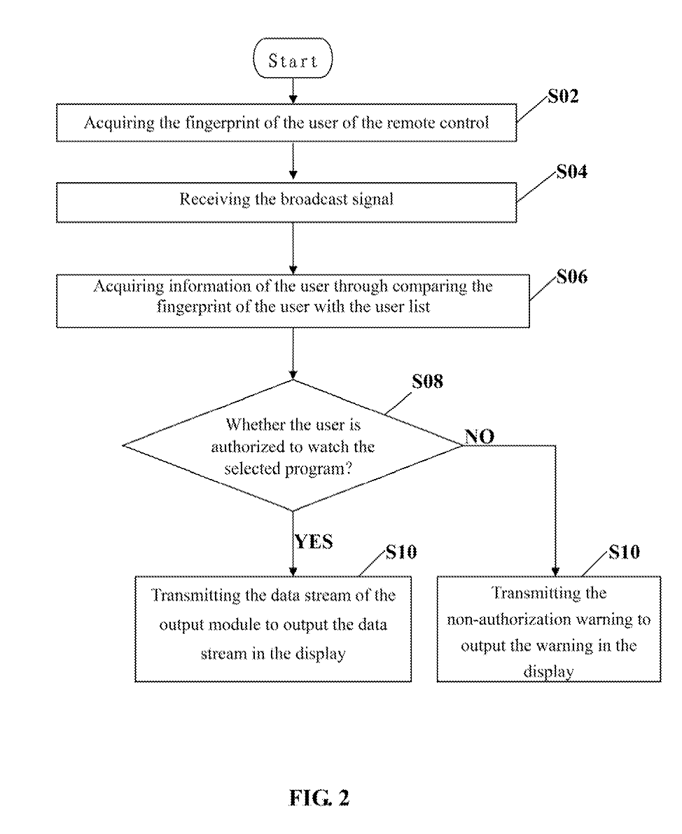

FIG. 2 is a flowchart of an exemplary embodiment of an authorizing method for playing media content of the present disclosure.

In block S02, the acquiring module 21 of the remote control 20 acquires the fingerprint of a user. The fingerprint of the user is acquired when the user operates the remote control 20.

In block S04, the television receiver 10 receives the broadcast signal. The broadcast signal includes program content of different channels and content labels under television rating guide.

In block S06, the content controlling module 13 acquires information of the user through comparing the fingerprint of the user with a user list pre-stored in the first storage 14.

In block S08, the content controlling module 13 compares the content label of the selected program with acquired information of the user to determine whether the user is authorized to watch the selected program.

In block S10, if the user is authorized according to the user list, the content controlling module 13 transmits the data stream of the output module 16 to output the data stream in the display 17. If the user is not authorized according to the user list, the content controlling module 13 transmits a non-authorization warning to the output module 13 to output the warning in the display 17.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A television authorizing system for playing media content comprising a storage and a display, comprising:
a communicating module that receives a broadcast signal;
a content controlling module that acquires a content label of selected program from the broadcast signal and compares the content label with the user information in a predefined user list to determine whether the user is authorized to watch the selected program; and
an output module that outputs the selected program to the display when the user is authorized, wherein the communicating module, the content controlling module and the output module is stored in the storage.

2. The television authorizing system of claim 1, wherein the broadcast signal includes program content of different channels and content labels under television rating guide.

3. The television authorizing system of claim 1, further comprising:
a processing module that transforms the broadcast signal into a data stream complying with a media format supported by the output module and displays the data stream in the display when the user is authorized.

4. The television authorizing system of claim 3, wherein the media format supported are MPEG, RMVB, Real Player and DVIX formats.

5. The television authorizing system of claim 1, wherein the predefined user list contains information including age and authority of watching media content for each user.

6. An authorizing method for playing media content, the method comprising:
acquiring a fingerprint information from a user;
receiving a broadcast signal comprising a program content of different channels and content labels under television rating guide;
acquiring the content label of a program selected from the program content;
comparing the content label with a predefined user list; and
displaying the selected program in a display when the user is authorized through comparing the content label with the predefined user list.

7. The authorizing method of claim 6, further comprising:
displaying a non-authorization warning in the display when the user is not authorized.

8. The authorizing method of claim 6, further comprising:
transforming the broadcast signal into a data stream complying with a media format supported by the output module and displays the data stream in the display when the user is authorized.

9. The authorizing method of claim 8, wherein the media format supported are MPEG, RMVB, Real Player and DVIX formats

10. The authorizing method of claim 8, wherein the predefined user list contains information including age and authority of watching media content for each user
